(19) United States
(12) Patent Application Publication
(10) Pub. No.: US 2026/0116179 A1
(43) Pub. Date: Apr. 30, 2026

(54) VEHICLE COMPONENT MOUNTING ASSEMBLY AND RELATED METHODS

(71) Applicant: CVF Motorsports, Inc., New Prague, MN (US)

(72) Inventor: Shawn Eric Fosness, Hastings, MN (US)

(21) Appl. No.: 19/374,983

(22) Filed: Oct. 30, 2025

Related U.S. Application Data
(60) Provisional application No. 63/714,457, filed on Oct. 31, 2024.

(51) Int. Cl. B60K 11/04; F16B 5/02

(52) U.S. Cl. CPC B60K 11/04; F16B 5/02

(57) ABSTRACT

A vehicle component mounting assembly including a base, an arm, and a fastener. The base is operably coupleable to a support substrate. The arm is operably coupled to the base, the arm being rotationally adjustable and translationally adjustable relative to the base. The fastener is operably coupled to the arm. The fastener is rotationally adjustable and translationally adjustable relative to the arm and the fastener is operably coupleable to a vehicle component.

### RELATED APPLICATIONS

This application claims the benefit of U.S. Provisional Application No. 63/714,457, filed Oct. 31, 2024, the entire contents of which are incorporated herein by reference.

### FIELD

This disclosure relates to assemblies for vehicle component mounting and related methods of use.

### BACKGROUND

Vehicle components, such as those found under a vehicle hood, can be mounted to a support surface or support substrate of a vehicle. During operation of the vehicle, it can be desirable for the vehicle components to mounted such that they experience little unnecessary movement, and vehicle components can be mounted to the vehicle with movement reduction in mind.

Specific hardware can be used to mount these components and maintain their positions. For example, vehicle radiators can be mounted using mounting brackets. However, mounting hardware can be limited, and changes in or modifications to vehicle components can require different mounting hardware to be installed. After-market modifications or replacement radiators, in particular, may require additional hardware.

### SUMMARY

In general, this disclosure relates to assemblies for vehicle component mounting and related methods. The vehicle component mounting assembly can include a base operably coupleable to a support substrate, an arm operably coupled to the base, the arm being rotationally adjustable and translationally adjustable relative to the base, and a fastener operably coupled with the arm. The fastener can be rotationally adjustable and translationally adjustable relative to the arm and the fastener is operably coupleable to a vehicle component.

The assemblies described herein can provide a variety of advantages. For example, the assemblies can be used at a variety of locations within the vehicle. The movement of the pivot arm can allow for horizontal or vertical mounting of the assembly. The adjustability of the clamp can further allow the assembly to be used with different vehicle components, which can vary in size.

One embodiment includes a vehicle component mounting assembly comprising a base operably coupleable to a support substrate, an arm operably coupled to the base, the arm being rotationally adjustable and translationally adjustable relative to the base, and a fastener operably coupled to the arm, wherein the fastener is rotationally adjustable and translationally adjustable relative to the arm and wherein the fastener is operably coupleable to a vehicle component.

In a further embodiment of the vehicle component mounting assembly, wherein the base comprises a first slot and the fastener comprises a second slot, the arm is operably coupled to the base at the first slot, and the arm is operably coupled to the fastener at the second slot, the first slot is configured for rotational adjustment of the arm and translational adjustment of the arm relative to the base, the second slot is configured for rotational adjustment of the arm and translational adjustment of the arm relative to the fastener, rotational adjustment of the arm comprises at least one of rotation of the arm in the first slot and rotation of the arm in the second slot, and translational adjustment of the arm comprises at least one of translational movement of the arm in the first slot and translational movement of the arm in the second slot. In this further embodiment, vehicle component mounting assembly further comprises a first connector disposed within the first slot to operably couple the arm to the base, the first connector being translationally and rotationally movable within the first slot, and a second connector disposed within the second slot to operably couple the arm to the fastener, the second connector being translationally and rotationally movable within the second slot. In this further embodiment of the vehicle component mounting assembly, the arm comprises a first arm member extending from a first connector first end to a second connector first end, and a second arm member extending from a first connector second end to a second connector second end, and wherein the first arm member and the second arm member define an opening therebetween, and wherein at least one of the base and the fastener are sized to be movable through the opening during at least one of rotational adjustment or translational adjustment of the arm relative to at least one of the base and the fastener.

In a further embodiment of the vehicle component mounting assembly, the fastener comprises an adjustable length, and wherein the length of the fastener can be adjusted to operably couple the fastener to the vehicle component.

In a further embodiment of the vehicle component mounting assembly, the arm comprises an arm slot configured to receive at least one of the base and the fastener, the arm slot being configured for at least one of rotational adjustment and translational adjustment of at least one of the base and the fastener, and wherein rotational adjustment of the at least one of the base and the fastener comprises rotating at least one of the base and the fastener in the arm slot, and translational adjustment of the at least one of the base and the fastener comprises translationally moving at least one of the base and the fastener in the arm slot.

Another embodiment of the vehicle component mounting assembly comprises a base operably coupleable to a vehicle surface, a pivot arm operably coupled to the base, and a clamp operably coupled to the pivot arm, wherein the clamp is configured to receive a vehicle component, wherein the pivot arm is configured to rotationally and translationally adjust a position of the clamp relative to the base.

In a further embodiment of the vehicle component mounting assembly, the base comprises a first slot, and the vehicle component mounting assembly further comprises a first connector operably coupling the pivot arm with the base at the first slot, wherein the first connector enables rotation of the base relative to the pivot arm, and the first connector defines a first axis of rotation about which the base rotates. In this further embodiment of the vehicle component mounting assembly, the base is rotatable up to 360 degrees around the first axis of rotation. In this further embodiment of a vehicle component mounting assembly, the first connector is translationally moveable within the first slot, and translational movement of the first connector in the first slot causes translational movement of the pivot arm relative to the base.

In a further embodiment of the vehicle component mounting assembly, the clamp comprises a second slot, the vehicle component mounting assembly further comprises a second connector operably coupling the pivot arm to the clamp at the second slot, the second connector enables rotation of the clamp relative to the pivot arm, and the second connector defines a second axis of rotation about which the clamp rotates. In this further embodiment of the vehicle component mounting assembly, the clamp is rotatable up to 360 degrees around the second axis of rotation. In a further embodiment of the vehicle component mounting assembly, the second connector is translationally moveable within the second slot, and translational movement of the second connector in the second slot causes translational movement of the pivot arm relative to the clamp.

In a further embodiment of the vehicle component mounting assembly, the clamp comprises a first jaw and a second jaw operably coupled to the first jaw, the first jaw and the second jaw being adjustable relative to one another to define a clamp length, and adjustment of the first jaw relative to the second jaw changes the clamp length.

Another embodiment includes a method of mounting a vehicle component comprising providing a mounting assembly, the mounting assembly comprising a base, an arm adjustably coupled to the base, and a fastener adjustably coupled to the arm, coupling the base to a vehicle surface, positioning the fastener to receive a vehicle component, and attaching the vehicle component to the mounting assembly using the fastener.

In a further embodiment of the method of mounting a vehicle component, positioning the mounting assembly to receive a vehicle component comprises rotationally adjusting at least one of the arm and the fastener. In this further embodiment, rotationally adjusting at least one of the arm and the fastener comprises at least one of rotating the arm in a first slot of the base, and rotating the arm in a second slot of the fastener.

In a further embodiment of the method of mounting a vehicle component, wherein positioning the fastener to receive a vehicle component comprises translationally moving at least one of the arm relative to the base and the fastener relative to the arm. In this further embodiment, translationally moving at least one of the arm relative to the base and the fastener relative to the arm comprises at least one of moving the arm in a first slot of the base, and moving the arm in a second slot of the fastener.

In a further embodiment of the method of mounting a vehicle component, the fastener comprises a length, and wherein attaching the vehicle component to the mounting assembly using the fastener comprises adjusting the length of the fastener until the vehicle component is secured by the fastener.

The details of one or more examples of the disclosure are set forth in the accompanying drawings and the description below. Other features, objects, and advantages of the disclosure will be apparent from the description and drawings, and from the claims.

### BRIEF DESCRIPTION OF FIGURES

The following drawings are illustrative of particular examples of the various embodiments contemplated herein and therefore do not limit the scope thereof. The drawings are not necessarily to scale, though embodiments can include the scale illustrated, and are intended for use in conjunction with the explanations in the following detailed description wherein like reference characters denote like elements. Examples will hereinafter be described in conjunction with the appended drawings.

FIG. 1A is a perspective view of an embodiment of a vehicle mounting assembly in a vehicle, in accordance with one or more examples of this disclosure.

FIG. 1B is a perspective view of an embodiment of a vehicle mounting assembly in a vehicle, in accordance with one or more examples of this disclosure.

FIG. 1C is a perspective view of an embodiment of a vehicle mounting assembly in a vehicle, in accordance with one or more examples of this disclosure.

FIG. 1D is a perspective view of an embodiment of a vehicle mounting assembly in a vehicle, in accordance with one or more examples of this disclosure.

FIG. 2A shows an illustrative configuration of a vehicle mounting assembly, in accordance with one or more examples of this disclosure.

FIG. 2B shows an illustrative configuration of a vehicle mounting assembly, in accordance with one or more examples of this disclosure.

FIG. 2C shows an illustrative configuration of a vehicle mounting assembly, in accordance with one or more examples of this disclosure.

FIG. 2D shows an illustrative configuration of a vehicle mounting assembly, in accordance with one or more examples of this disclosure.

FIG. 2E shows an illustrative configuration of a vehicle mounting assembly, in accordance with one or more examples of this disclosure.

FIG. 3A is a perspective view of an embodiment of a vehicle mounting assembly, in accordance with one or more examples of this disclosure.

FIG. 3B is a bottom view of an embodiment of a vehicle mounting assembly, in accordance with one or more examples of this disclosure.

FIG. 4A is a perspective view of a base of a vehicle mounting assembly, in accordance with one or more examples of this disclosure.

FIG. 4B is a side view of a base of a vehicle mounting assembly, in accordance with one or more examples of this disclosure.

FIG. 4C is a top view of a base of a vehicle mounting assembly, in accordance with one or more examples of this disclosure.

FIG. 5A is a perspective view of a pivot arm of a vehicle mounting assembly, in accordance with one or more examples of this disclosure.

FIG. 5B is a top view of a pivot arm of a vehicle mounting assembly, in accordance with one or more examples of this disclosure.

FIG. 5C is a bottom view of a pivot arm of a vehicle mounting assembly, in accordance with one or more examples of this disclosure.

FIG. 6A is a perspective view of a first clamp frame of a vehicle mounting assembly, in accordance with one or more examples of this disclosure.

FIG. 6B is a side view of a first clamp frame of a vehicle mounting assembly, in accordance with one or more examples of this disclosure.

FIG. 6C is a bottom view of a first clamp frame of a vehicle mounting assembly, in accordance with one or more examples of this disclosure.

FIG. 7A is a perspective view of an adjustable clamp arm of a vehicle mounting assembly, in accordance with one or more examples of this disclosure.

FIG. 7B is a front view of an adjustable clamp arm of a vehicle mounting assembly, in accordance with one or more examples of this disclosure.

FIG. 8 is a perspective view of an adjustable clamp arm including bumpers of a vehicle mounting assembly, in accordance with one or more examples of this disclosure.

FIG. 9 is a side view of another embodiment of a vehicle mounting assembly, in accordance with one or more examples of this disclosure.

FIG. 10 is a flow diagram of a method of use of a vehicle mounting assembly, in accordance with one or more examples of this disclosure.

### DETAILED DESCRIPTION

The description herein is directed to assemblies for use in mounting vehicle components. The embodiments herein can be used to mount various components within a vehicle and can be fastened to a support substrate (e.g., a surface within the body of the vehicle) to position a vehicle component relative to the support substrate.

In particular, the assemblies herein can be used to position cooling system components in vehicles. This can, in some applications, include radiators. Radiators can vary in size and/or location depending on the vehicle in which the radiator is used. Mounting assemblies for these radiators can be specifically designed for the radiator itself, which may mean that additional mounting hardware may be needed when replacing radiators in a vehicle. As a result, after-market radiator modifications or replacements may be enhanced by additional mounting hardware. The assemblies described herein can be configured to be adjusted to accommodate for different radiator sizes and/or locations. In some applications, radiators can be mounted adjacent to/in proximity to the core support of the vehicle.

While the embodiments herein are described in the context of mounting a radiator to a core support, it should be understood that the assemblies described herein may be used to mount vehicle components other than cooling system components such as radiators. The assemblies described herein can also be used to mount other cooling system components, such as universal coolers, transmission coolers, and/or oil coolers, or any other cooler. The vehicle mounting assembly 10 can mount such components at various locations within the vehicle, as will be discussed in further detail below. Assemblies described herein can be used to mount any component of a vehicle coolant system and can be mounted to any surface at or near a vehicle coolant system. Additionally or alternatively, the assemblies herein may be mounted to support substrates other than the core support of a vehicle.

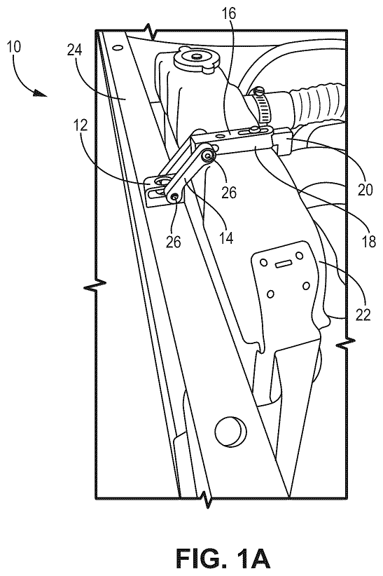

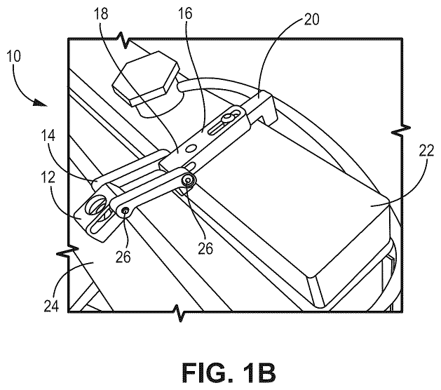

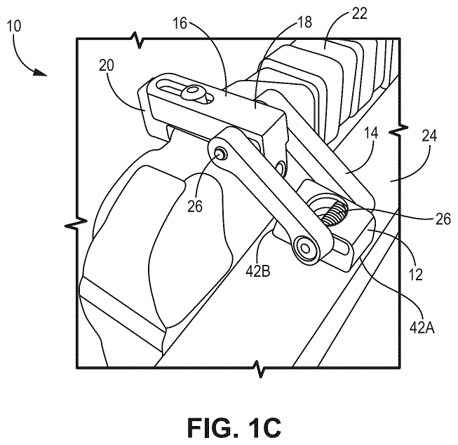

FIG. 1A-1D each show various applications of a vehicle mounting assembly 10. The vehicle mounting assembly 10 can include a base 12, a pivot arm 14, and a mounting clamp 16 including a first clamp frame 18 and a second clamp frame 20. In some embodiments, the vehicle mounting assembly 10 can be used to mount a vehicle component 22 to a mounting surface 24. The vehicle component 22 can be positioned within the clamp 16, and the base 12 can be affixed to the mounting surface 24 during use. The mounting surface 24 can be a core support, which can serve as a mounting surface for the cooling system components such as the vehicle radiator 22.

The pivot arm 14 is connected to the base 12 and the clamp 16 and the pivot arm 14 can move relative to one or both of the base 12 and the clamp 16 at the location of attachment to each. A connector, for example connector 26 shown in FIG. 1A, may be used at the location of such connections to provide the above-mentioned relative motion. For example, the pivot arm 14 can rotate relative to either or both of the base 12 and the clamp 16. In some embodiments, the pivot arm 14 can rotate up to 360 degrees relative to the base 12. The pivot arm 14 can also move relative to the base 12 and/or the clamp 16, providing for a range of translational motion within and/or around the base 12 and/or the clamp 16. The range of translational movement of the pivot arm 14 can be the approximate length of the base 12, according to some embodiments.

The translational movement of the pivot arm 14 can allow the vehicle mounting assembly 10 to be mounted to a variety of locations. For example, the assembly 10 can be mounted on horizontal surfaces and vertical surfaces, as well as on angled surfaces. In addition, the pivot arm 14 can extend above the base 12 (e.g., a distal end of the pivot arm 14 may be positioned higher than a proximal end of the pivot arm 14 coupled to the base 12, as depicted in FIG. 1A). Alternatively, the base 12 can be mounted such that the pivot arm 14 is suspended therefrom (e.g., a distal end of the pivot arm 14 may be positioned lower than a proximal end of the pivot arm 14 coupled to the base 12, as depicted in FIG. 1B). Movement of the pivot arm 14 within the base 12 can allow the base 12 to be mounted on a support or mounting surface 24 on any side of the vehicle component 22. This mobility can allow the assembly 10 to be used in a variety of applications and vehicles with varying distances/positions between the vehicle component 22 and mounting surface 24.

The translational movement of the pivot arm 14 can facilitate the positioning of the assembly 10. Such movement can account for varying differences in distance between a mounting surface 24 and vehicle component 22 in different vehicles. The translational movement of the pivot arm 14 can reduce or increase the distance between the base 12 and clamp 16, which can allow for a variety of applications of the assembly 10. Additionally or alternatively, the translational movement of the pivot arm 14 may also account for differences in component sizing. For example, a vehicle component 22 may be replaced by another component having a different width, which may affect the distance between component 22 and mounting surface 24. Translational movement of the pivot arm 14 can allow the assembly 10 to be used in instances where replacement of parts would affect this distance.

FIG. 1A shows the assembly 10 in use, wherein the clamp 16 is positioned over the vehicle component 22. The vehicle component 22 may extend to a greater height than the mounting surface 24. The pivot arm 14 can position the clamp 16 at a height above the base 12. That is, the clamp 16 can be positioned at a height above the mounting surface 24 during use. The clamp 16 can be oriented into such a position by rotating the pivot arm 14 relative to the base 12.

In other applications, the clamp 16 can be positioned at a height lower than the base 12 during use, as shown in FIG. 1B. In such applications, the mounting surface 24 can be disposed at a greater height than the vehicle component 22. In FIG. 1B, the assembly 10 is mounted to an alternative mounting surface 24 than that of FIG. 1A. In addition, the radiator 22 of FIG. 1B is an alternative radiator configuration than that of FIG. 1A. The pivot arm 14 can be rotated relative to the base 12 to adjust for this difference in height. In addition, the pivot arm 14 can move translationally relative to the base 12 to account for the distance between the mounting surface 24 and the vehicle component 22.

FIG. 1C shows another embodiment of the assembly 10. Similar to the positioning of FIG. 1A, attaching the assembly 10 to the vehicle component 22 can require the clamp 16 to be positioned at a greater height than the mounting surface 24. Due to the distance between the vehicle component 22 and the support substrate 24, the pivot arm 14 may be positioned at a different location within the base 12 than the position shown in FIG. 1A. For example, the pivot arm 14 may be positioned at an approximate halfway point between a first end 42A and a second end 42B of the base 12 and can be translationally moved to said position. The pivot arm 14 can be positioned at any location between the first and second ends 42A, 42B of the base 12.

The placement of the pivot arm 14 can account for an increase or decrease in the distance between the mounting surface 24 and vehicle component 22. The position of the pivot arm 14 within the base 12 and clamp 16 can determine the approximate length of the assembly 10 such that the assembly 10 can be used in multiple applications of mounting a vehicle component 22 to a mounting surface 24.

In some applications, such as that of FIG. 1D, the assembly 10 can be mounted on the side on a vertical mounting surface 24. The clamp 16 can attach to the vehicle component 22 at any surface of the vehicle component 22 fitting within the clamp 16. The assembly 10 can be used at any location wherein a vehicle component 22 fits within the clamp 16 and the base 12 attaches to a surface 24 of the vehicle, such as the core support shown in FIG. 1D. In other applications, the assembly 10 can be attached to other structures, such as, but not limited to, frame rails and/or fire walls. The assembly 10 can be obscured from view once installed within a vehicle.

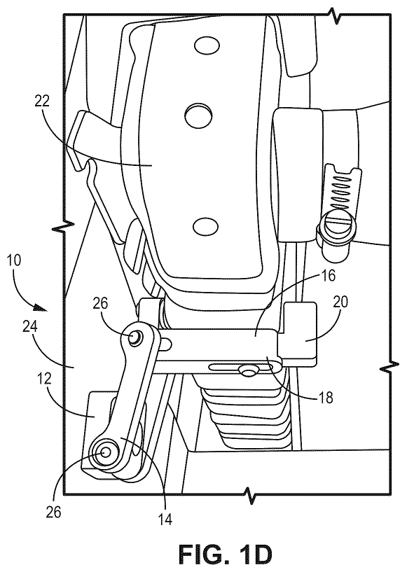

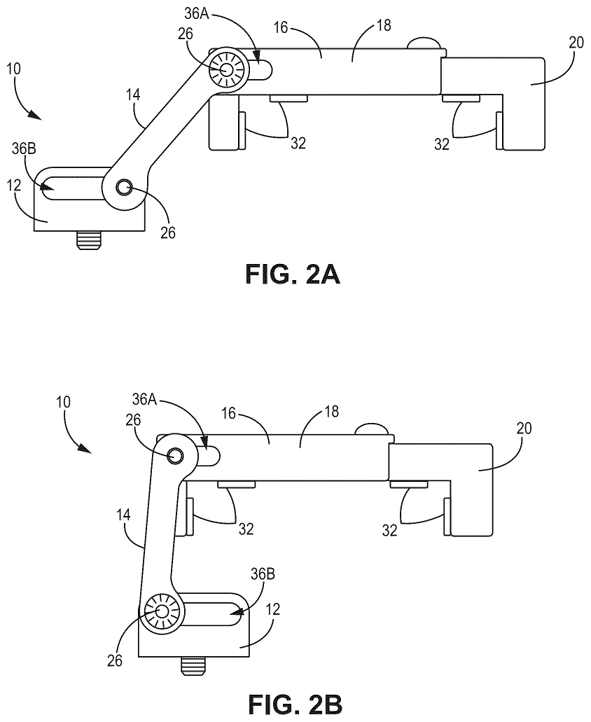

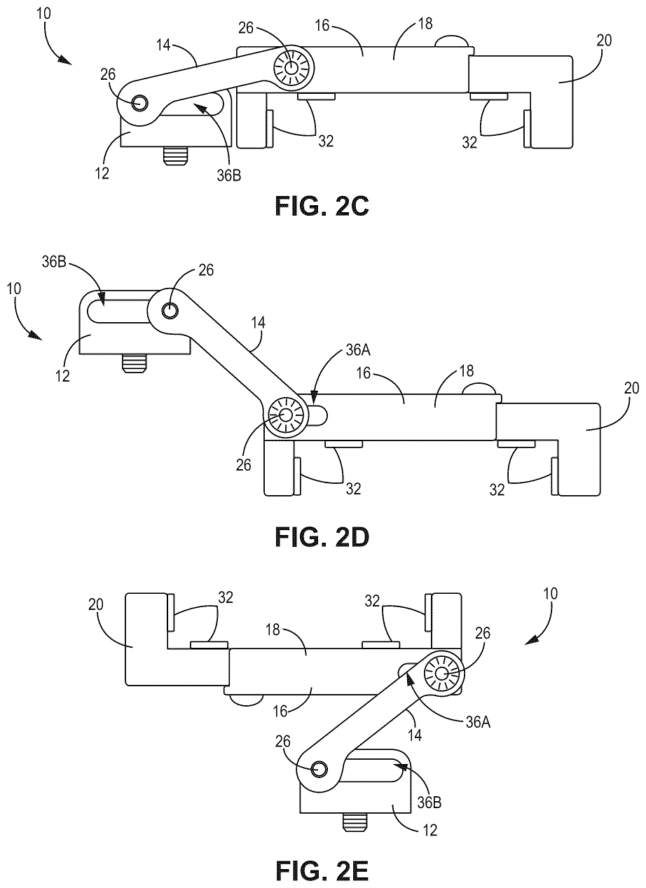

As shown in FIGS. 1A-1D, the assembly 10 can be oriented in a variety of configurations. FIG. 2A-2E each show additional various illustrative mounting configurations of the vehicle mounting assembly 10. FIG. 2A shows an illustrative positioning of the base 12 relative to the clamp 16. Base 12 and clamp 16 each include pivot arm slots 36A, 36B. Each of the pivot arm slots 36A, 36B are sized to receive a portion of the pivot arm 14 therethrough such that the pivot arm 14 can move translationally and/or rotationally within the slots 36A, 36B (e.g., first slot 36A and second slot 36B are each configured to enable translational and rotational adjustment of the pivot arm 14 in each slot). In some embodiments, the pivot arm slots 36A, 36B are sized to receive a connector 26 therethrough such that the pivot arm 14 can move translationally and/or rotationally relative to the slots 36A, 36B.

The assembly 10 can be increased or reduced in length by a total of the approximate combined length of the pivot arm slots 36A, 36B. In some applications, the assembly 10 can be modified in length by at least a portion of the approximate combined length of the pivot arm slots 36A, 36B. Such a modification can be achieved by moving the pivot arm 14 within the base 12 and/or clamp 16 to a selected location therein. The position of the pivot arm 14 can be modified by moving the pivot arm 14 within pivot arm slots 36A, 36B, and the pivot arm 14 can be attached to both components at the pivot arm slots 36A, 36B. The pivot arm 14 can be at any location within the pivot arm slots 36A, 36B. As shown in FIG. 2A, the pivot arm 14 is disposed at an approximate 45-60 degree angle relative to the base 12 and/or the base mounting surface 24.

FIG. 2B shows an alternative illustrative orientation of the base 12 and the clamp 16. In FIG. 2B, the pivot arm 14 is about 90 degrees relative the base 12 and/or base mounting surface 24. The pivot arm 14 can also be generally perpendicular to the clamp 16. In other applications, the clamp 16 can be rotated to any position about the pivot arm 14 while the pivot arm 14 is generally perpendicular to the base 12.

FIG. 2C shows an alternative illustrative orientation of the base 12 and the clamp 16. In some applications, the pivot arm 14 can be at an angle of about 30 degrees or less relative to the mounting surface 24, thereby positioning the clamp 16 adjacent to the base 12. In applications where the base 12 is mounted to a horizontal surface, the clamp 16 may be approximately level to the mounting surface 24.

FIG. 2D shows another alternative illustrative orientation of the base 12 and the clamp 16. The pivot arm 14 may be at an approximate −45 degree to approximate −60 degree orientation relative to the base 12. In applications where the base 12 is mounted to a horizontal surface, the clamp 16 may be disposed at a lower height than the height of the mounting surface 24.

FIG. 2E shows yet another illustrative orientation of the assembly 10. In this embodiment, the clamp 16 can be positioned above the base 12 and be rotated to be such that the clamp 16 is positioned below a vehicle component. The clamp 16 can be rotated relative to the pivot arm 14 to be positioned below the vehicle component, and, in some instances, can be rotated approximately 180 degrees from the positions shown in FIG. 2A-2D. While FIG. 2E depicts clamp 16 as being rotated approximately 180 degrees, clamp 16 can be rotated up to 360 degrees, as will be discussed further elsewhere herein.

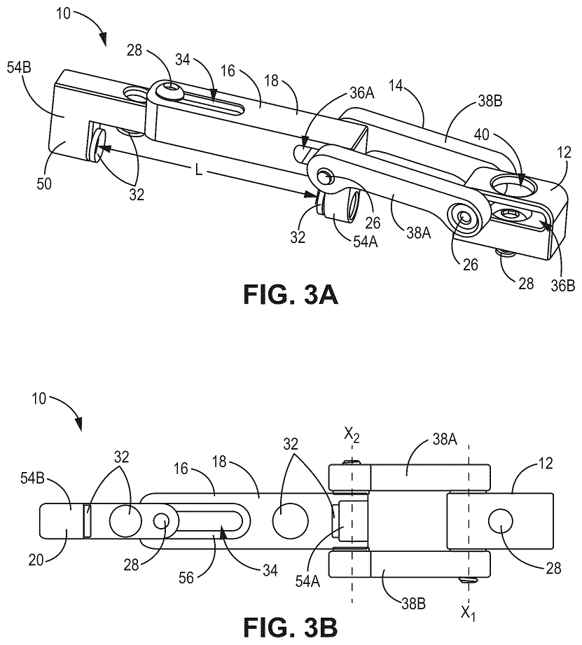

FIG. 3A and FIG. 3B (collectively referred to herein as FIG. 3) each show the vehicle mounting assembly 10 including a base 12, a pivot arm 14, and a clamp 16. Each of the various components can be fastened to one another via various mechanical fasteners (e.g., fastening screws 26, 28, also referred to herein as “connectors”), as will be discussed in further detail elsewhere herein.

The clamp 16 can have a first and second clamp frame 18, 20, each including various features. For example, the first clamp frame 18 can include a second clamp frame fastening slot 34 and a first adjustment slot 36A. and the pivot arm 14 can be attached to the clamp 16 at the first adjustment slot 36A. A pivot arm fastener 26 (also referred to herein as a “connector”) can be positioned within the adjustment slot 36A such that the pivot arm 14 is translationally and/or rotationally moveable within the first adjustment slot 36A. Fastener 26 can define an axis of rotation x₂ around which the clamp 16 can rotate. Clamp 16 is rotatable up to 360 degrees around the axis of rotation x₂. Translational movement of the clamp 16 in slot 36A causes translational movement of axis of rotation x₂.

The clamp 16 can be configured to receive a vehicle component. Clamp frames 18, 20 can each include a jaw 54A, 54B, respectively. The second clamp frame 20 can be attached to the first clamp frame 18 at the frame fastening slot 34. The second clamp frame 20 may not move within the frame fastening slot 34 once the second clamp frame 20 is fastened thereto. The second clamp frame 20 can be positioned relative the first clamp frame 18 using a positioning screw 28.

The first and second clamp frames 18, 20 can be adjusted relative to one another. The second clamp frame 20 can be positioned against the first clamp frame 18 at a lip 56, shown in FIG. 3B. The length L of the clamp 16 can be defined by the distance between clamp jaws 54A, 54B, and the length L can then be adjusted by moving the second clamp frame 20 along the lip 56. Adjusting the length of the clamp 16 can include changing the distance between the jaws 54A, 54B of the clamp 16. This can adjust the clamp 16 for use with various components, such as different vehicle radiators. The length L of the clamp 16 can range from 1.5 inches, 2 inches, 2.5 inches, 3 inches, to 3.5 inches. Thus, the clamp 16 can be adjusted to fit over and/or around vehicle components of varying sizes. The clamp 16 can be adjusted when replacing components such as a radiator, and can allow a user to replace components with those of potentially varying size without needing to purchase additional mounting hardware.

Different configurations of adjustable clamps/fasteners may be used with the embodiments described herein. For example, adjustable C-clamps, bar clamps, hand screw clamps, or any other clamp having an adjustable jaw may be used with the embodiments described herein. The assemblies described herein can be used with any clamp having an adjustable jaw that can be configured for use with a pivot arm 14. That is, any adjustable clamp with a frame that can be modified to have a slot can be used in combination with a pivot arm such as pivot arm 14 (or any other pivot arm configuration) can be used with the embodiments described herein. A clamp frame can have a slot (such as pivot arm slot 36) that can receive a pivot arm. When the pivot arm is attached to the frame of the clamp, the pivot arm can move translationally and/or rotationally relative to the clamp and the clamp jaws can be adjusted. Movement of the pivot arm within the clamp frame may be independent of pivot arm movement within the base.

The clamp frames 18, 20 can each include components configured to interface with vehicle components. In some embodiments, the first and second clamp frames 18, 20 can each include at least one bumper 32. The clamp length can be adjusted such that the bumpers contact the vehicle component 22 during use. In some embodiments, both the first and second clamp frames 18, 20 can include a bumper 32 on the surfaces contacting a vehicle component, such as the radiator 22. The bumpers can prevent vibration, movement, noise, and/or damage to the component held by the clamp 16. Other dampers may also be used.

The clamp 16 can be attached to the vehicle via the base 12. The clamp 16 is attached to the base 12 using the pivot arm 14. The base 12 can include various features, which can be used to connect the base 12 to the pivot arm 14 and/or a mounting surface 24. For example, the base 12 can be configured to receive a fastener 28 that fastens the base 12 to a support surface or a support substrate, or even to another vehicle component in some embodiments. In some embodiments, the fastener 28 can be a threaded fastener. The base can include a fastener access opening 40 configured to allow a tool (such as a screwdriver or wrench) to access the fastener 28.

The base 12 can include a second pivot arm slot 36B. The second pivot arm slot 36B can be used to position the pivot arm 14 relative to the base 12 and can be configured to receive a fastener 26. The second pivot arm slot 36B can extend along an approximate length of the base 12, and the fastener 26 can move translationally within the second pivot arm slot 36B.

The pivot arm 14 can connect the base 12 and clamp 16. The pivot arm 14 can include two pivot arm members 38A, 38B. The pivot arm members 38A, 38B can be fixed relative to one another using mechanical fasteners 26. When the pivot arm members 38A, 38B are fixed relative to one another, the pivot arm members 38A, 38B can be generally parallel to one another.

The fasteners 26 connecting the pivot arm members 38A, 38B can be used to position the pivot arm 14 within the first and second pivot arm slots 36A, 36B. Each pivot arm slot 36A, 36B can be sized to receive the fasteners 26 and allow translational and rotational movement of the fasteners 26 therein. For example, each fastener 26 can rotate about a central axes x₁, x₂ within each slot 36A, 36B. The fastener 26 may also move translationally within each slot 36A, 36B. Movement in one slot may be independent of movement in the remaining slot. For example, the clamp 16 may be moved relative to the pivot arm 14 by movement of the pivot arm 14 at the first pivot arm slot 36A without movement of the pivot arm 14 within the second pivot arm slot 36B. Similarly, the pivot arm 14 may be moved relative to the base 12 in the second pivot arm slot 36B without movement of the pivot arm 14 relative to the clamp 16 at the first pivot arm slot 36A.

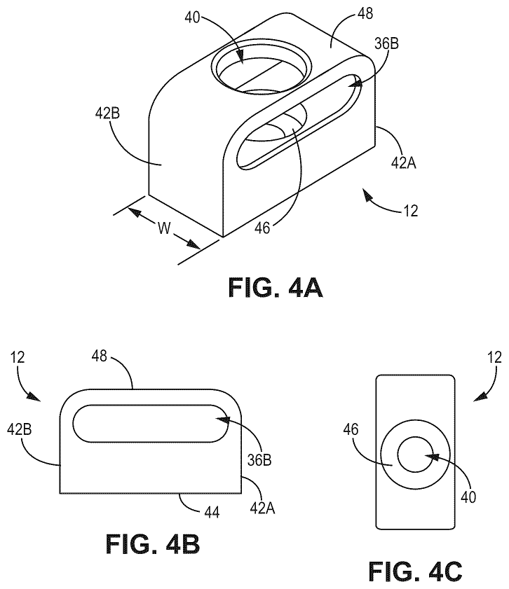

FIG. 4A-4C (collectively discussed herein as FIG. 4) each show the base 12. The base 12 has a first end 42A and second end 42B opposite the first end 42A. The second pivot arm slot 36B can extend from approximately the first end 42A to the second end 42B and can extend the width W of the base. During use, the pivot arm fastener 26 can be disposed within the second pivot arm slot 36B and can move from the first end 42A to the second end 42B of the slot 36B. Base 12 can rotate around fastener 26 such that fastener 26 defines an axis of rotation x₁ about which the base rotates. The base may rotate up to 360 degrees around this axis of rotation x₁. Translational movement of the fastener 26 in slot 36B causes translational movement of pivot arm 14 relative to base 12. Translational movement also moves the axis of rotation x₁.

The base 12 can include features for the fastening of the base 12 to a vehicle component and/or surface 24. For example, a fastener (such as fastener 28 of FIG. 3) can be inserted though fastener access opening 40. A tool can tighten the fastener 28 until the fastener contacts a seat 46. The fastener 28 can be used to mount the base 12 to a mounting surface 24.

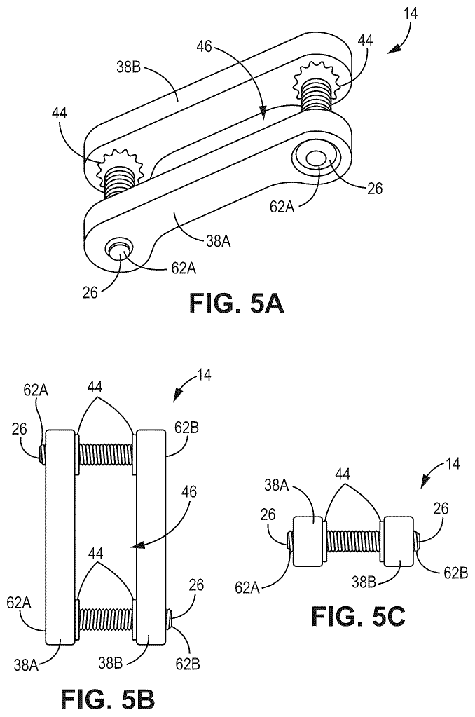

FIG. 5A-5C (collectively discussed herein as FIG. 5) each show the pivot arm 14 of a vehicle mounting assembly 10. The pivot arm 14 can have two pivot arm members 38A, 38B. The pivot arm members 38A, 38B can be generally parallel to one another and positioned relative to one another using a plurality of mechanical fasteners 26. Pivot arm members 38A, 38B can be positioned at opposite ends 62A, 62B (also referred to herein as first end 62A and second end 62B) of the mechanical fasteners 26. The distance between the members 38A, 38B can be greater than the width of the base 12 and/or the clamp 16. This can allow the pivot arm 14 to rotate freely about the base 12 and clamp 16. The space 48 between the fasteners 26 may be unobstructed to allow for rotational movement and translational movement of the pivot arm 14.

The pivot arm 14 can include a plurality of washers 44. Washers 44 can be positioned around the fasteners 26 adjacent the pivot arm members 38A, 38B. In some embodiments, these can be lock washers 44. The lock washers 44 can be star lock washers. In other embodiments, the washers 44 may have a different shape. The washers 44 can prevent the pivot arm members 38A, 38B from movement and/or slipping. During use of the vehicle, the washers 44 can mitigate noise caused by movement of the pivot arm members 38A, 38B such as rattling. Additionally or alternatively, other components configured to reduce sound may be used to mitigate noise.

While the embodiments herein include a pivot arm 14 having two members 38A, 38B, other pivot arm configurations may be included in the assembly 10. For example, some embodiments of the pivot arm 14 may include one pivotable member 38. Other embodiments can include three or more pivotable members 38. In some embodiments, the pivot arm 14 may be adjustable in length and/or width. For example, the length or distance between fasteners 26 of the pivot arm 14 may be adjustable to account for distance between the vehicle component 22 and mounting surface 24. In other embodiments, the width of the pivot arm 14 may be less than or approximately equal to that of the base 12.

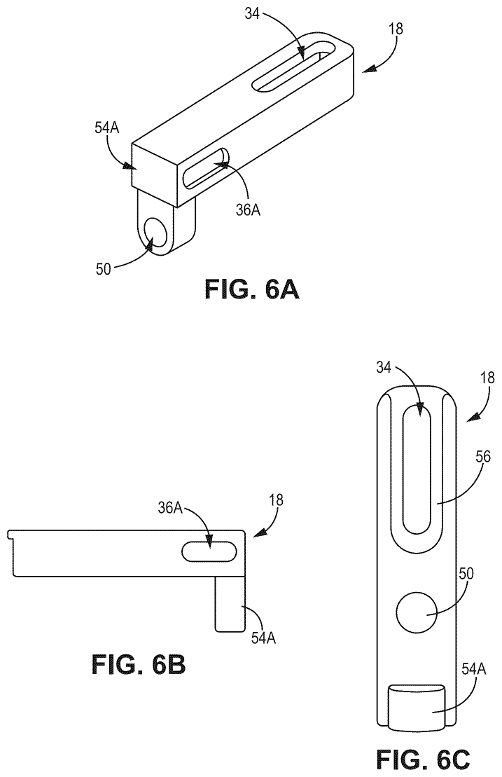

FIG. 6A-6C (collectively discussed herein as FIG. 6) each show the first clamp frame 18 of the claim 16. The first clamp frame 18 can have a first jaw 54A. First jaw 54A can include a bumper slot 50. A bumper 32 (e.g., a rubber bumper) can be inserted into the bumper slot 50. The first clamp frame 18 can be fastened to the second clamp frame 20, forming clamp 16.

The first clamp frame 18 can include a plurality of openings. For example, the first clamp frame 18 can include a first pivot arm slot 36A. The pivot arm 14 can be fastened to the first clamp frame 18 using a fastener 26, as discussed elsewhere herein. The first clamp frame 18 can also include a frame fastening slot 34. The frame fastening slot 34 can receive a fastener, such as threaded fastener 28. The first clamp frame 18 can also include at least one bumper slot 50.

FIG. 6C shows a bottom view of the first clamp frame 18. The first clamp frame 18 can include a lip 56. The second clamp frame 20 can be attached to the first clamp frame 18 at the lip 56 by positioning the second clamp frame 20 against the lip 56. The second clamp frame 20 can then be adjustably fastened therein.

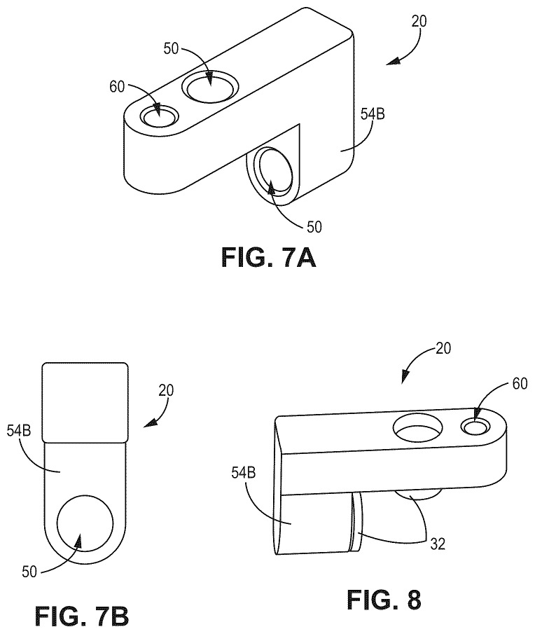

FIG. 7A-7B (collectively discussed herein as FIG. 7) show the second clamp frame 20. The second clamp frame 20 can include a second jaw 54B and can include a plurality of openings. For example, the second clamp frame 20 can include bumper slots 50, in which various bumpers 32 can be inserted (as shown in FIG. 8). In addition, the second clamp frame 20 can include a fastener opening 60. The fastener opening 60 can be positioned against the second clamp frame 20 at a location within the frame fastening slot 34. A fastener 28 can be inserted into fastener opening 60 and attach the first and second clamp frame 18, 20 to one another.

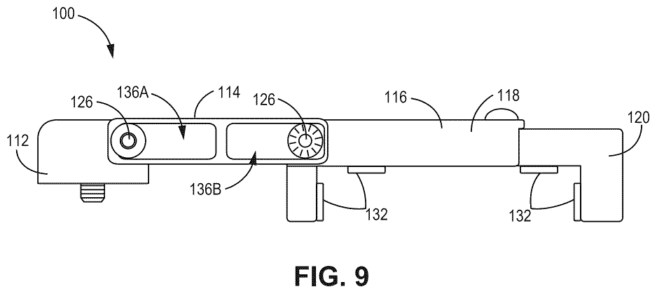

FIG. 9 shows an alternative embodiment of the assembly 100. The assembly 100 includes a base 112, pivot arm 114, and clamp 116. Clamp 116 and base 112 are operably coupled to the pivot arm 114, and are translationally and rotationally adjustable relative to the pivot arm 114.

The pivot arm 114 can include structural features configured to translationally and/or rotationally position the base 112 and the clamp 116. Pivot arm 114 can include a first slot 136A and a second slot 136B. The base 112 and clamp 116 can include structural features, such as fasteners 126, configured to couple base 112 and clamp 116 to the pivot arm 114 at pivot arm slots 136A, 136B. The position of base 112 and clamp 116 can be adjusted by moving the fasteners 126 in the pivot arm slots 136A, 136B. Base 112 and clamp 116 can be rotationally moved and/or translationally moved in the slots 136A, 136B.

The base 112 and clamp 116 can each include an opening (not pictured) that are each configured to receive a fastener 126 therethrough. When the fastener 126 is positioned within the opening of base 112 and clamp 116, the fasteners 126 can be configured to not undergo translational movement relative to base 112 and clamp 116 (e.g., fasteners 126 can be threadably coupled to the base 112 and clamp 116). Additional components, such as washers, can be positioned adjacent the fasteners 126 on the base 112 and clamp 116 to reduce wear and noise from vibration and other forces during operation of a vehicle.

Fasteners 126 can be configured to move within slots 136A, 136B, thereby allowing a user to position the base 112 and clamp 116 relative to pivot arm 114. Each slot 136A, 136B can be approximately the same length, and each slot can be approximately half of the length of the pivot arm 114. In other embodiments, the pivot arm can have one slot having a length approximate the length of the pivot arm, and the base and clamp can be positioned at any location and/or angle within the slot. The assembly can include any slot configuration configured to allow a user to translationally and/or rotationally adjust the position of the base relative to the clamp.

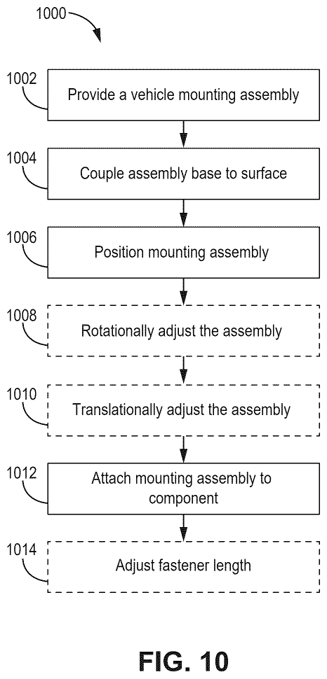

FIG. 10 shows a method of use of a vehicle component mounting assembly (1000). The method includes providing a vehicle component mounting assembly (1002), coupling the base to a vehicle surface (1004), positioning the mounting assembly to receive a vehicle component (1006), and attaching the mounting assembly, using the fastener (or clamp) of the vehicle component mounting assembly, to the vehicle component (1012). The provided vehicle mounting assembly can be any of the vehicle component mounting assemblies described herein, such as assembly 100 of FIG. 3A-3B.

Positioning the mounting assembly to receive a vehicle component can include rotationally adjusting the assembly (1008) For example, a user can rotationally adjust at least one of the arm and the clamp. Rotationally adjusting the arm can include rotating the arm in the first slot of the base. Similarly, rotationally adjusting the fastener can include rotating the arm in the second slot of the fastener.

Additionally or alternatively, positioning the mounting assembly to receive a vehicle component can include translationally adjusting the assembly (1010). Translational adjustment of the assembly can include translationally moving at least one of the arm relative to the base and the fastener relative to the arm. This can include at least one of moving the arm in the first slot of the base and moving the arm in the second slot of the fastener.

Once the mounting assembly has been positioned, the fastener can be adjusted. The fastener can have a length, and the length of the fastener can be adjusted until the vehicle component is secured within the fastener (1014). For example, in embodiments of the vehicle component mounting assembly including a clamp, the clamp length can be adjusted until the vehicle component is clamped by the assembly. This positions the vehicle component and restricts its movement. In some applications, this can include positioning the vehicle component adjacent a bumper or other damper.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount-including any integer-between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

What is claimed is:

1. A vehicle component mounting assembly, comprising:
(a) a base operably coupleable to a support substrate;
(b) an arm operably coupled to the base, the arm being rotationally adjustable and translationally adjustable relative to the base; and
(c) a fastener operably coupled to the arm, wherein the fastener is rotationally adjustable and translationally adjustable relative to the arm and wherein the fastener is operably coupleable to a vehicle component.

2. The vehicle component mounting assembly of claim 1, wherein:
the base comprises a first slot and the fastener comprises a second slot,
the arm is operably coupled to the base at the first slot, and the arm is operably coupled to the fastener at the second slot,
the first slot is configured for rotational adjustment of the arm and translational adjustment of the arm relative to the base,
the second slot is configured for rotational adjustment of the arm and translational adjustment of the arm relative to the fastener,
rotational adjustment of the arm comprises at least one of rotation of the arm in the first slot and rotation of the arm in the second slot, and
translational adjustment of the arm comprises at least one of translational movement of the arm in the first slot and translational movement of the arm in the second slot.

3. The vehicle component mounting assembly of claim 2, further comprising:
a first connector disposed within the first slot to operably couple the arm to the base, the first connector being translationally and rotationally movable within the first slot, and
a second connector disposed within the second slot to operably couple the arm to the fastener, the second connector being translationally and rotationally movable within the second slot.

4. The vehicle component mounting assembly of claim 3, wherein the arm comprises:
(a) a first arm member extending from a first connector first end to a second connector first end; and
(b) a second arm member extending from a first connector second end to a second connector second end, and
wherein the first arm member and the second arm member define an opening therebetween, and wherein at least one of the base and the fastener are sized to be movable through the opening during at least one of rotational adjustment or translational adjustment of the arm relative to at least one of the base and the fastener.

5. The vehicle component mounting assembly of claim 1, wherein the fastener comprises an adjustable length, and wherein the length of the fastener can be adjusted to operably couple the fastener to the vehicle component.

6. The vehicle component mounting assembly of claim 1, wherein:
the arm comprises an arm slot configured to receive at least one of the base and the fastener,
the arm slot being configured for at least one of rotational adjustment and translational adjustment of at least one of the base and the fastener, and wherein:
rotational adjustment of the at least one of the base and the fastener comprises rotating at least one of the base and the fastener in the arm slot, and
translational adjustment of the at least one of the base and the fastener comprises translationally moving at least one of the base and the fastener in the arm slot.

7. A vehicle component mounting assembly, comprising:
(a) a base operably coupleable to a vehicle surface;
(b) a pivot arm operably coupled to the base; and
(c) a clamp operably coupled to the pivot arm, wherein the clamp is configured to receive a vehicle component,
wherein the pivot arm is configured to rotationally and translationally adjust a position of the clamp relative to the base.

8. The vehicle component mounting assembly of claim 7, wherein:
the base comprises a first slot,
the vehicle component mounting assembly further comprises a first connector operably coupling the pivot arm with the base at the first slot, wherein:
the first connector enables rotation of the base relative to the pivot arm, and
the first connector defines a first axis of rotation about which the base rotates.

9. The vehicle component mounting assembly of claim 8, wherein the base is rotatable up to 360 degrees around the first axis of rotation.

10. The vehicle component mounting assembly of claim 8, wherein:
the first connector is translationally moveable within the first slot, and
translational movement of the first connector in the first slot causes translational movement of the pivot arm relative to the base.

11. The vehicle component mounting assembly of claim 7, wherein:
the clamp comprises a second slot,
the vehicle component mounting assembly further comprises a second connector operably coupling the pivot arm to the clamp at the second slot,
the second connector enables rotation of the clamp relative to the pivot arm, and
the second connector defines a second axis of rotation about which the clamp rotates.

12. The vehicle component mounting assembly of claim 11, wherein the clamp is rotatable up to 360 degrees around the second axis of rotation.

13. The vehicle component mounting assembly of claim 11, wherein:
the second connector is translationally moveable within the second slot, and
translational movement of the second connector in the second slot causes translational movement of the pivot arm relative to the clamp.

14. The vehicle component mounting assembly of claim 7, wherein:
the clamp comprises a first jaw and a second jaw operably coupled to the first jaw, the first jaw and the second jaw being adjustable relative to one another to define a clamp length, and adjustment of the first jaw relative to the second jaw changes the clamp length.

15. A method of mounting a vehicle component, the method comprising:
providing a mounting assembly, the mounting assembly comprising:
(a) a base;
(b) an arm adjustably coupled to the base; and
(c) a fastener adjustably coupled to the arm,
coupling the base to a vehicle surface;
positioning the fastener to receive a vehicle component; and
attaching the vehicle component to the mounting assembly using the fastener.

16. The method of claim 15, wherein positioning the mounting assembly to receive a vehicle component comprises rotationally adjusting at least one of the arm and the fastener.

17. The method of claim 16, wherein rotationally adjusting at least one of the arm and the fastener comprises at least one of:
rotating the arm in a first slot of the base; and
rotating the arm in a second slot of the fastener.

18. The method of claim 15, wherein positioning the fastener to receive a vehicle component comprises translationally moving at least one of the arm relative to the base and the fastener relative to the arm.

19. The method of claim 18, wherein translationally moving at least one of the arm relative to the base and the fastener relative to the arm comprises at least one of:
moving the arm in a first slot of the base; and
moving the arm in a second slot of the fastener.

20. The method of claim 15, wherein the fastener comprises a length, and wherein attaching the vehicle component to the mounting assembly using the fastener comprises adjusting the length of the fastener until the vehicle component is secured by the fastener.
